(19) United States
(12) Patent Application Publication
(10) Pub. No.: US 2002/0159027 A1
(43) Pub. Date: Oct. 31, 2002

(54) Device for manufacturing of square edge memory lens

(76) Inventor: Kok-Ming Tai, Lawrenceville, GA (US)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 10/106,695

(22) Filed: Mar. 26, 2002

Related U.S. Application Data
(60) Provisional application No. 60/279,195, filed on Mar. 27, 2001.
(60) Provisional application No. 60/334,753, filed on Oct. 31, 2001.

(51) Int. Cl. G02C 7/02; B25B 11/00

(52) U.S. Cl. 351/177; 269/8

(57) ABSTRACT

A collet for holding a lens includes a first member having a first end and a second end that defines a first surface capable of engaging the first side of the lens. A second member has a third end and a fourth end that defines a second surface capable of engaging the second side of the lens. At least a selected one of the first member and the second member includes a magnetic coupler that is capable of providing attractive magnetic force between the second end of the first member and the third end of the second member, thereby supporting a lens there between. A selected one of the first member or the second member also includes an exterior surface that is capable of being secured to a mandrill of a lathe.

### CROSS REFERENCE TO A PROVISIONAL APPLICATION

This patent application claims priority on Provisional Application Serial No. 60/279,195, filed on Mar. 27, 2001, and 60/334,753 filed Oct. 31, 2001, the entirety of which are hereby incorporated by reference.

### BACKGROUND OF THE INVENTION

1. Field of the Invention

The present invention relates to devices for manufacturing lenses and, more specifically, to a device for manufacturing lenses having a square peripheral edge.

2. Description of the Prior Art

A conventional method of manufacturing lenses involves lathing the lens from a cylindrical blank of a lens material (such a cylindrical blank is commonly referred to as a “button”). The buttons are typically cut initially from rod stock or sheets, or individually cast in cups using a curable liquid monomer composition.

While it is possible in some cases to insert the button directly into a lathe collet, it is more typical to first attach the button to a separate metal block, the opposite end of which is configured for removable insertion into the collet of the lathe. The button is typically adhered to the block with an adhesive. While the block and button are turned, the desired concave (or “base”) curve is lathed into the exposed end of the button opposite the adhered end. Subsequently, this semi-finished button is removed from this first base curve metal block.

Then, this partially-finished button is adhered to a second metal block such that the lathe cut base curve of the button is adhered to the second metal block, again typically with pitch, while attempting to maintain proper alignment vis-a-vis the second metal block and the cut base curve. This front curve metal block is mounted to a lathe collet for lathing the convex curve from the button. Subsequently, the lens must be removed from the front curve metal block.

The lathing process involves securing the lens mold in a chucking device or collet that fixes the mold in coaxial alignment with the lathe spindle. A cutting tool is then brought into with the rotating mold, with the tool arranged and programmed to follow various pathways to achieve the desired finished surface.

These operations may also involve intermediate lathing operations, for example, cutting a desired precision thickness or cutting an edge chamfer in the button, prior to lathing the front curve. Also, typically these operations will involve lens edging and polishing operations on the lathe cut surfaces.

Current memory lenses are manufactured using a lathing process and are then polished by tumbling. The tumbling process removes the lathe marks to provide a quality surface. However, the tumbling process tends to round the edge of the lens, which in some applications is an undesirable artifact of the tumbling process. There is no lathing process that enables a wet lens to be securely held while being processed.

Therefore, there is a need for a mechanism that generates lenses with square edges.

### SUMMARY OF THE INVENTION

The invention employs a magnetic collet that uses magnetic attraction to clamp the central part of the lens, while exposing the edges to be processed. The magnetic forces generated are sufficient to hold the lens and also have a self centering property. The collet system includes a lens centering adapter and a magnet guide. The collet system allows the lens to be held while a cutting tool removes material from the circumference of the lens, thereby allowing for the cutting of a square edge on the completed lens. This process enables a lens to be finished with a square edge after the final lathing process is completed.

The disadvantages of the prior art are overcome by the present invention which, in one aspect, is a collet for holding a lens, having a first side and an opposite second side, during a lathing process. The collet includes a first member and a second member. The first member has a first end and a spaced apart second end. The second end defines a first surface capable of engaging the first side of the lens. The second member has a third end and a spaced apart fourth end. The third end defines a second surface capable of engaging the second side of the lens. At least a selected one of the first member and the second member includes a magnetic coupler that is capable of providing attractive magnetic force between the second end of the first member and the third end of the second member, thereby supporting a lens there between. A selected one of the first member or the second member also includes an exterior surface that is capable of being secured to a mandrill of a lathe.

In another aspect, the invention is a method of cutting a square edge on a lens having a first surface, an opposite second surface, and an outward peripheral edge. In the method, a first member is attached to the mandrill of a drill. The first member has a first end and an opposite second end that is shaped complimentary to a surface of the lens. The first surface of the lens is mounted on the second end of the first member. A second member is placed against the second surface of the lens. The second member has a third end and an opposite fourth end. The third end is shaped complimentary to the second surface of the lens. The second member is magnetically attractive to the first member so as to hold the lens there between. The mandrill of the drill is rotated and a cutting tool is applied to the outward peripheral edge of the lens so as to cut a substantially flat surface on the outward peripheral edge of the lens.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top perspective view of a collet according to the invention and a lens.

FIG. 2A is a cross sectional view of a lens mounted onto a collet.

FIG. 2B is a cross sectional view of a lens mounted onto a collet with a cutting tool being applied to the lens edge.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

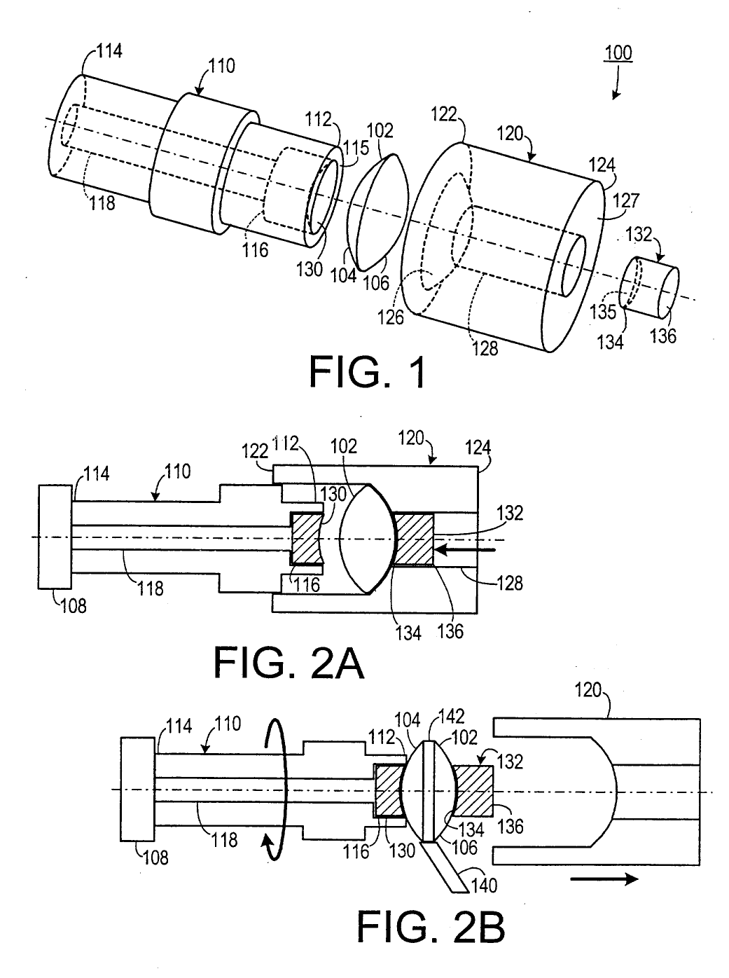

As shown in FIG. 1, one embodiment of the invention is a collet 100 for holding a lens 102 having a first side 104 and an opposite second side 106, during a lathing process. The collet 100 includes a first member 110, a second member 132, that is magnetically attracted to the first member 110 and an alignment tool 120 for centering the second member 132 on the lens 102.

The first member 110 has a first end 114 and a spaced apart second end 112. The second end 112 defines a first surface 115 capable of engaging the first side 104 of the lens 102. The second member 132 has a third end 134 and a spaced apart fourth end 136. The third end 134 defines a second surface 135 capable of engaging the second side 106 of the lens 102. The first member 110 includes a magnetic insert 130 that is attractive to the second member 132 (which could also be a magnet). The magnetic attraction between the first member 110 and the second member 132 supports the lens 102 during the lathing process.

The first member 110 includes a cylinder that defines a first bore 118 extending from the first end 114 toward the second end 116 and a second bore 116 extending from the second end 112 toward the first end 114. The diameter of the second bore 116 is grater than the diameter of the first bore 118. The magnetic insert 130 is disposed within the second bore 116. The surface of the magnetic insert 116 is complimentary in shape to a portion of the first side 104 of the lens 102 so that the lens 102 fits closely against the magnetic insert 116.

Both the magnetic insert 130 and the second member 132 could be made of neodymium, which can be highly magnetized. A thin coating, such as a lacquer of the type used with electronic components, may be applied to both the magnetic insert 130 and the second member 132 to prevent scratching of the lens 102.

The magnetic insert 130 could be made from a porous magnetic material. This would allow a vacuum to be applied to the lens through the first bore 118 and the second bore 118, thereby causing greater holding force to be applied to the lens 102.

The alignment tool 120 includes a mating surface 126 that is shaped complimentary to a portion of the second side 106 of the lens 102, and an opposite exterior surface 127. The alignment tool 120 defines a second member placement bore 128 that extends longitudinally from the mating surface 126 to the exterior surface 127 and has a shape that allows the second member 132 to be placed in the placement bore 128 and moved to a position that is adjacent the second side 106 of the lens 102.

As shown in FIGS. 2A and 2B, the lens 102 is placed against the first member 110, which is affixed to the mandrill 108 of a drill (not shown). The alignment tool 120 is placed against the second side 106 of the lens 102 and the second member 132 is slid through the second member placement bore 128 until it is against the second side 106 of the lens 102. The alignment tool is then removed from the lens 102 and the second member 132. The magnetic attraction between the first member 110 and the second member 132 supports the lens 102. The mandrill 108 is rotated and a cutting tool 140 is applied to the outward peripheral edge of the lens 102 to cut a substantially flat surface 142.

While the lens 102 shown in the figures is convex on both sides, it should be understood that any lens configuration would work with the invention, including concave-concave and concave-convex, so long as the lens mating surfaces of the first member 110 and the second member 132 are shaped complimentary to the shape of the lens surface with which they are in contact.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A collet for holding a lens, having a first side and an opposite second side, during a lathing process, comprising:
a. a first member having a first end and a spaced apart second end, the second end defining a first surface capable of engaging the first side of the lens; and
b. a second member having a third end and a spaced apart fourth end, the third end defining a second surface capable of engaging the second side of the lens;
at least a selected one of the first member and the second member comprising a magnetic coupler, capable of providing attractive magnetic force between the first member and the second member, thereby supporting a lens there between, a selected one of the first member or the second member also including an exterior surface that is capable of being secured to a mandrill of a lathe.

2. The collet of claim 1, wherein the first member comprises:
a. a cylinder defining a bore extending from the second end toward the first end; and
b. a first magnet disposed within the bore and a first magnet surface that is complimentary in shape to a portion of the first side of the lens.

3. The collet of claim 2, wherein the first magnet comprises neodymium.

4. The collet of claim 2, wherein the first magnet further comprises a coating to prevent scratches on the lens.

5. The collet of claim 1, wherein the first member comprises:
a. a cylinder defining a first bore, having a first diameter, extending from the first end toward the second end and defining a second bore extending from the second end toward the first end, the second bore having a second diameter that is greater than the first diameter; and
b. a first magnet disposed within the second bore and having a third diameter that is less than the second diameter and greater than the first diameter, the first magnet having a first magnet surface that is complimentary in shape to a portion of the first side of the lens.

6. The collet of claim 5, wherein the first magnet comprises neodymium.

7. The collet of claim 5, wherein the first magnet further comprises a coating to prevent scratches on the lens.

8. The collet of claim 5, wherein the first magnet comprises a porous material, thereby allowing a vacuum to be applied to the lens through the first bore and the second bore.

9. The collet of claim 1, wherein the second member comprises a second magnet having a second magnet surface that is complimentary in shape to a portion of the second side of the lens.

10. The collet of claim 9, wherein the second magnet comprises neodymium.

11. The collet of claim 9, wherein the second magnet further comprises a coating to prevent scratches on the lens.

12. The collet of claim 1, further comprising an alignment tool capable of aligning the second member with the first member when applying the second member to the lens.

13. The collet of claim 12, wherein the alignment tool comprises a block having a mating surface and an opposite exterior surface, the mating surface shaped complimentary to a portion of the second side of the lens and defining a second member placement bore extending longitudinally from the mating surface to the exterior surface and having a shape that allows the second member to be placed in the placement bore and moved to a position that is adjacent the second side of the lens.

14. A method of cutting a square edge on a lens having a first surface, an opposite second surface, and an outward peripheral edge, the method comprising the steps of:
a. attaching a first member, having a first end and an opposite second end, the second end being shaped complimentary to a surface of the lens, to a mandrill of a drill;
b. mounting the first surface of the lens on the second end of the first member;
c. placing a second member against the second surface of the lens, the second member having a third end and an opposite fourth end, the third end being shaped complimentary to the second surface of the lens, the second member being magnetically attractive to the first member so as to hold the lens there between;
d. rotating the mandrill of the drill; and
e. applying a cutting tool to the outward peripheral edge of the lens so as to cut a substantially flat surface on the outward peripheral edge of the lens.

15. The method of claim 14, wherein the step of placing the second member against the second surface comprises the steps of:
a. placing an alignment tool against a portion of the second surface of the lens, the alignment tool defining a longitudinal bore extending from a mating surface to an opposite surface;
b. placing the second member into the longitudinal bore and moving the second member to a position that is adjacent the second surface of the lens; and
c. removing the alignment tool from the second surface of the lens and the second member, thereby leaving the second member to apply force to the lens toward the first member.
